(19) United States
(12) Patent Application Publication
(10) Pub. No.: US 2007/0242036 A1
(43) Pub. Date: Oct. 18, 2007

(54) Dual control data entry

(75) Inventors: Andrew D. Wilson, Seattle, WA (US); Maneesh Agrawala, Berkeley, CA (US)

Correspondence Address: MICROSOFT CORPORATION, ONE MICROSOFT WAY, REDMOND, WA, 98052-6399, US

(73) Assignee: Microsoft Corporation, Redmond, WA (US)

(21) Appl. No.: 11/405,224

(22) Filed: Apr. 17, 2006

(51) Int. Cl. G09G 5/00

(52) U.S. Cl. 345/156

(57) ABSTRACT

Alphanumeric input is achieved using a handset having a limited number of controls but at least two controls—a first control and a second control. A key layout is rendered on a display. The key layout includes two parts—a first part and a second part. One of the two controls of the handset is associated with one of the two parts of the key layout such that characters within that part are selected with the one control. Likewise, the other of the two controls is associated with the other of the two parts of the key layout such that characters within the other part are selected with the other control.

### BACKGROUND

Video games are an enormously popular pastime for very many people. Typically, a video game platform makes use of handheld controllers that allow a user to control the game play. Generally, these handheld controllers include a very limited set of buttons, usually distributed about the controller. In addition, the handheld controllers usually include at least one and usually two joystick controls which are simpler to use when playing a game.

With conventional gaming platforms, often times there may be a need or desire to enter text while playing a game or perhaps while setting up the game console. Unfortunately, text entry is very difficult with the limited controls that exist on many handsets that come with conventional game platform.

An adequate text entry mechanism for use with a limited handset, such as a game controller, has eluded those skilled in the art, until now.

### SUMMARY

This summary is provided to introduce a selection of concepts in a simplified form that are further described below in the Detailed Description section. This summary is not intended to identify key features or essential features of the claimed subject matter, nor is it intended to be used to limit the scope of the claimed subject matter.

According to aspects of various described embodiments, implementations are provided for achieving alphanumeric input using a handset having a limited number of controls but at least two controls—a first control and a second control. A key layout is rendered on a display. The key layout includes two parts—a first part and a second part. One of the two controls of the handset is associated with one of the two parts of the key layout such that characters within that part are selected with the one control. Likewise, the other of the two controls is associated with the other of the two parts of the key layout such that characters within the other part are selected with the other control. Advantageously, this system enables a user to use both hands to enter data, which speeds data input. Using a simulated QWERTY layout for the key layout further enhances the efficiency.

### BRIEF DESCRIPTION OF THE DRAWINGS

FIG. 1 is an illustration of a sample handset that may be used in certain implementations of the present invention.

FIG. 2 illustrates one specific implementation of a key layout that may be used in certain implementations of the present invention.

FIG. 3 is a sample graphical interface that implements one embodiment of the invention.

FIG. 4 is a functional block diagram generally illustrating components of a system that implements a two-part key layout in accordance with one implementation of the invention.

FIG. 5 is an operational flow diagram generally illustrating operations performed in a process for achieving text input, in accordance with one implementation of the invention.

### DETAILED DESCRIPTION

Various embodiments are described more fully below with reference to the accompanying drawings, which form a part hereof, and which show specific exemplary implementations for practicing various embodiments. However, other embodiments may be implemented in many different forms and should not be construed as limited to the embodiments set forth herein; rather, these embodiments are provided so that this disclosure will be thorough and complete. Embodiments may be practiced as methods, systems or devices. Accordingly, embodiments may take the form of a hardware implementation, an entirely software implementation, or an implementation combining software and hardware aspects. The following detailed description is, therefore, not to be taken in a limiting sense.

The logical operations of the various embodiments are implemented (1) as a sequence of computer implemented steps running on a computing system and/or (2) as interconnected machine modules within the computing system. The implementation is a matter of choice dependent on the performance requirements of the computing system implementing the embodiment. Accordingly, the logical operations making up the embodiments described herein are referred to alternatively as operations, steps or modules.

Briefly stated, a technique and mechanism are presented for entering alphanumeric data using a limited handset, such as a video game controller. A virtual keyboard is presented in two parts with each part being associated with a different input control on the handset. With this system, a user can use both hands to enter data with a game controller in a familiar manner similar to a conventional keyboard.

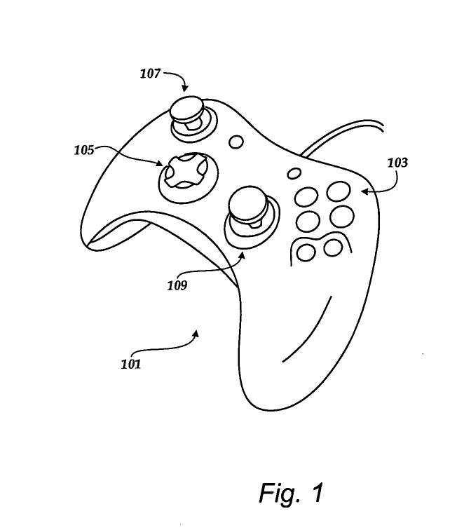

FIG. 1 is an illustration of a sample handset 101 that may be used in certain implementations of the present invention. The handset 101 may be used to control various electronics systems, such as video game consoles, special purpose computing systems, or general purpose computing systems. In this example, the handset 101 is specially designed for the purpose of playing video games, and accordingly has a limited number of input mechanisms. More specifically, the handset 101 includes only a few selection buttons 103, a directional pad 105, and two small joysticks (left joystick 107 and right joystick 109). The selection buttons 103 may be located at various locations around the handset 101 for ease of access by different parts of the hand. The directional pad 105 is functionally equivalent to four buttons (up, down, left, right) interconnected with a rocker panel. The joystick controls (107, 109) provide continuous or analog signal input which is very often advantageous while gaming.

In this embodiment, the handset 101 is part of a system that enables two-handed alphanumeric input by mapping two different controls to two different portions of a virtual or simulated keyboard layout. More specifically, in one particular implementation the left joystick 107 is mapped to a left part of a virtual keyboard that may be displayed by a system to which the handset 101 is coupled. Similarly, the right joystick 109 is mapped to a right part of the virtual keyboard. Individual characters on the virtual keyboard are selected by manipulating the control on the handset that corresponds to the part of the keyboard in which the character resides. In this manner, a user enters alphanumeric data on-screen with both hands, which results in quicker data entry over conventional alphanumeric data entry techniques. In addition, it is possible that characters can even be selected simultaneously as the user could be using both hands to simultaneously operate both controls to select characters in both parts of the virtual keyboard.

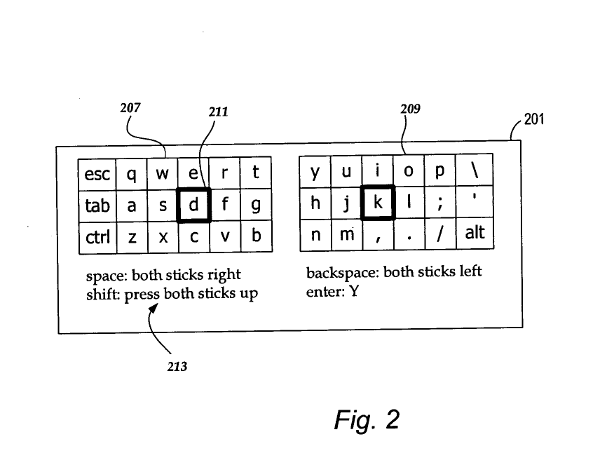

FIG. 2 illustrates one specific implementation of a key layout 201 that may be used in certain implementations of the present invention. The key layout 201 is a graphical representation of characters that may be selected while entering data. It is envisioned that the key layout 201 resembles a keyboard. More specifically, the inventors envision that the characters of the key layout 201 are arranged as they would be in a conventional ‘QWERTY’ keyboard. In this way, each of the characters appears in a familiar location, which shortens the time required to become proficient with this input mechanism. Although described here in the context of a ‘QWERTY’ layout, it should be appreciated that other layouts could also be used without departing from the spirit of the invention. In other words, the key layout 201 represents any configuration of characters in a display.

In this implementation, the key layout 201 is separated into two parts, a left part 207 and a right part 209. The left part 207 generally includes roughly half of the characters in the key layout 201, and the right part 209 generally includes roughly the other half. As suggested above, one control (e.g., the left joystick 107) is mapped to the left part 207, and another control (e.g., the right joystick 109) is mapped to the right part 209. These respective controls are then used to select a character within the part of the key layout 201 that corresponds to the control. In other words, the control that is mapped to the left part 207 is used to select characters in the left part 207, and the control that is mapped to the right part 209 is used to select characters in the right part 209.

Selecting a character may be achieved by using the controls to navigate a highlight indicator (a “halo” 211) to a desired character within the control's corresponding part of the key layout. Although described here as a “halo,” any other mechanism for identifying a highlighted or selected character could be used, such as colors, shading, animations, three dimensional effects, or the like. Once the user becomes sufficiently proficient with the input mechanism and controls, it is even possible that the user could operate both controls, one with each hand, to simultaneously select two characters.

By way of example, to select the letter “s”, a user uses the control that corresponds to the left part 207 of the key layout 201 (e.g., the left joystick 107) to navigate the left halo 211 to the “s” and then indicates the selection. Indicating the selection may be performed in any one or more of many ways, such as by pressing another control (e.g., a selection button 103) or the like.

Similarly, to select the letter “j”, which appears in the right part 209 of the key layout 201, the user uses the control (e.g., the right joystick 109) that corresponds to the right part 209 of the key layout 201. Using that control, the user navigates the right halo to the letter “j” and indicates the selection. In this way, the user is using both hands to enter text in a manner similar to an ordinary computer keyboard, which is familiar to many (if not most) video gamers.

Helpful information can be displayed on screen in conjunction with the key layout. For example, certain special characters may justify special treatment, and be given direct access through different control combinations or movements. For instance, the space character is so frequently used during text entry that a special sequence may be used to give direct access to that character, such as simultaneously pressing both controls in one direction. To assist the user in remembering this special sequence (and others), a hint 213 can be displayed on screen in conjunction with the key layout.

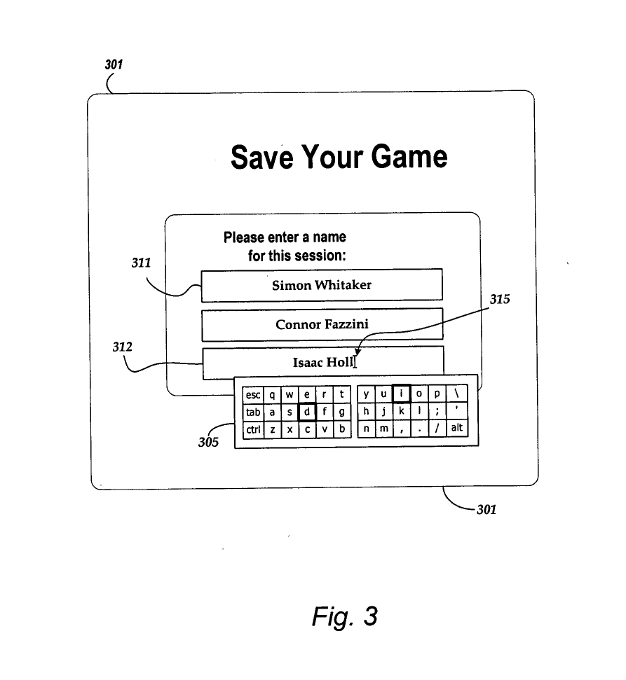

FIG. 3 is a sample graphical interface that implements one embodiment of the invention. In this implementation, an on-screen display 301 includes one or more textual input fields, such as field 311 and field 312, and a key layout 305. The key layout 305 functions substantially as described above and enables two-handed text entry using a limited handset, such as a game controller. Of note in this implementation is the placement of the key layout 305 on the display 301, and more specifically, the placement of the key layout with relation to the particular input field that is currently active or which currently has focus.

In other words, in this implementation, the key layout 305 is dynamically positioned on the display 301 such that it is near the current location of the active insertion point. In the example illustrated in FIG. 3, the insertion point 315 is at the end of the existing text within input field 312. For that reason, the key layout 305 is located proximate to that input field 312, and somewhat centered about the insertion point 315. This placement helps to reduce the eye movement necessary for the user to enter text, thus further enhancing the user's input experience. The inventors view the advantages provided by this implementation as additive to the core functionality enabled by embodiments of the invention. As such, this enhancement can be omitted from other implementations of the invention.

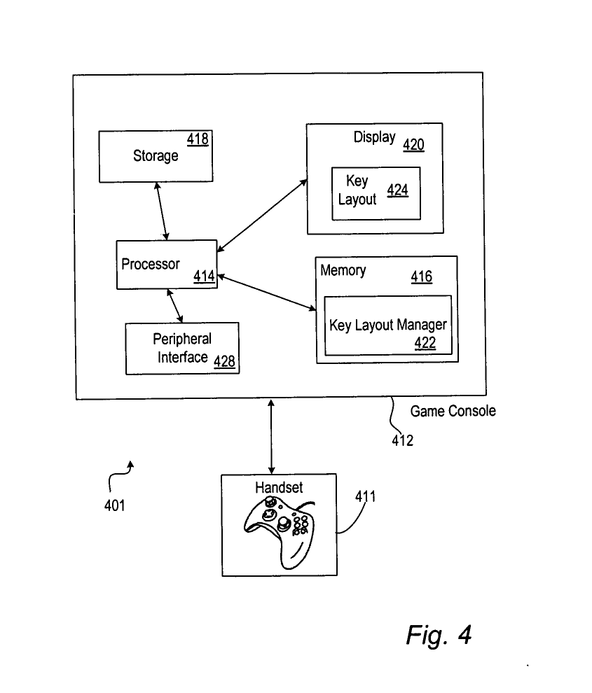

FIG. 4 is a functional block diagram generally illustrating components of a system 401 that implements a two-part key layout in accordance with one implementation of the invention. As shown, the system 401 includes a handset 411 and a game console 412. The handset 411 could be any input mechanism that includes at least two controls (e.g., joysticks, selection pads, trigger buttons, directional buttons, any combination of these, or the like). The handset 411 of this particular example is configured substantially as shown in FIG. 1 and described above.

The game console 412 could be any type of computing device that accepts input from the handset 411. In this particular example, the game console 412 is a stand alone video gaming platform that allows a user to play video games, often stored on optical disks, using a video display, such as a television set. In other implementations, the game console 412 could be any form of electronic device, such as a general purpose computer, with which the user interacts using the handset 411.

The game console 412 of this implementation includes a processor 414, a system memory 416, a storage 418, and a display 420. Other implementations could include more or perhaps even fewer components. The processor 414 could be a general purpose central processing unit, or it could be a special purpose processor, such as a digital signal processor (DSP) or an Application Specific Integrated Circuit (ASIC). The storage 418 is any medium that can be used to store information in a non-volatile or semi-volatile manner. For example, the storage 418 could be a hard disk, an optical disk drive, a Read Only Memory (ROM), a Programmable ROM (PROM), flash memory, or the like. System memory 416 is any memory in which computing instructions can be executed by the processor 414, such as conventional Random Access Memory (RAM) or perhaps certain types of flash memory. One example of computing instructions that may be executed in the system memory 416 is a key layout manager 422, described in greater detail below.

A display 420 includes components to generate and render a video image on a video output device, such as a computer monitor or a television set (not shown). The display 420 of this example includes an on screen representation of a key layout 424, substantially as shown in FIG. 2 and described above.

A peripherals interface 428 is included in the game console 412 to manage the interaction between the game console 412 and any external components, such as, for example, printers, scanners, and controllers (e.g., the handset 411).

In operation, the processor 414 loads instructions, such as a game, into the system memory 416 from the storage 418. Additionally, the key layout manager 422 is loaded into system memory 416. If at some point textual input becomes necessary or desirable, the key layout manager 422 causes the key layout 424 to be rendered on the display, and accepts notification of signals from the handset via the peripherals interface 428. The key layout manager 422 associates signals from one control of the handset 411, such as a first joystick, with one part of the key layout 424. The key layout manager 422 associates signals from another control of the handset 411, such as a second joystick, with another part of the key layout 424. The key layout manager 422 performs text input based on the combination of signals from each of the two controls.

What follows next is a description of a generalized process that implements one embodiment of the invention. This process may be implemented using computer-executable instructions in software or firmware, but may also be implemented in other ways, such as with programmable logic, electronic circuitry, or the like. In some alternative embodiments, certain of the operations may even be performed with limited human intervention. Moreover, this process is not to be interpreted as exclusive of other embodiments, but rather is provided as illustrative only.

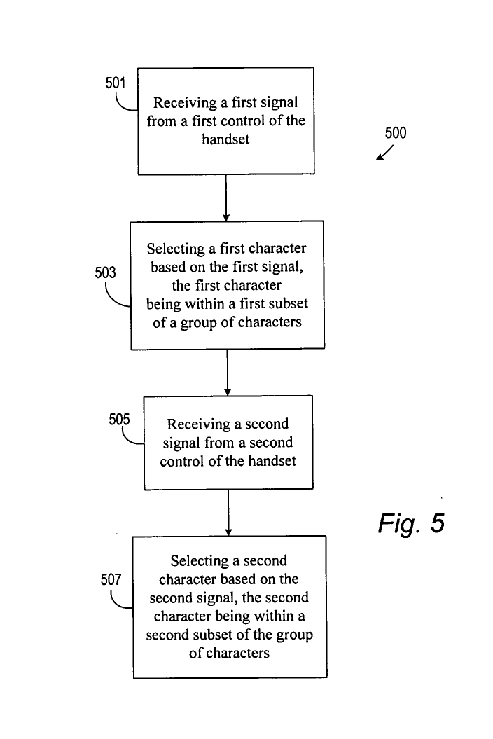

FIG. 5 is an operational flow diagram generally illustrating operations performed in a process for achieving text input, in accordance with one implementation of the invention. The process may be performed on a computing device, such as a video game console. The process includes steps for achieving data input using a handset having at least two controls. This description of the process begins at block 501, illustrated in FIG. 5.

At block 501, a first signal is received from a first control of the handset. In one specific example, the handset may be a game controller and the first control may be a joystick. In other implementations, these components can differ.

At block 503, a first character is selected based on the first signal. The first character is in a first subset of a group of characters. The group of characters may be an alphabet arranged in a key layout, such as a QWERTY key layout.

At block 505, a second signal is received from a second control of the handset. The second control could be another joystick of the game controller.

At block 507, a second character is selected based on the second signal. The second character is in a second subset of the group of characters.

As used within the process 500, the first and second subsets of the group of characters are distinguished according to spatial relationships between the characters in the group of characters as rendered on a graphical display. In one specific implementation, the first subset of characters is one part of a key layout, and the second subset of characters is another part of the key layout. For example, the first subset of characters could be a left half of the key layout and the second subset of characters could be the right half.

It should be appreciated that as used throughout this document, and in the above process and appended claims in particular, the adjectives “first” and “second” are used to distinguish between two substantially separate groups and are not being used to imply order. Accordingly, a “second signal” may be received before or after a “first signal,” without regard to the identifiers “second” and “first” respectively.

Although the process shown in FIG. 5 is illustrated and described sequentially with operations occurring in a particular order, in other embodiments, the operations described in the blocks may be performed in different orders, multiple times, and/or in parallel. Further, in some embodiments, one or more operations described in the blocks may be separated into another block, omitted or combined.

There are very many alternative ways to implement the concepts of the invention, all of which the inventors intend as being within the scope of the appended claims. Many such alternatives have been suggested or touched upon above throughout this detailed discussion, and many more, too numerous to enumerate, are equally possible.

For example, the illustrative embodiments given above make use of two joysticks for data entry. However, any other type of selection device could equally be used, such as directional buttons, regular selection buttons, and the like. In addition, the key layouts described throughout implement the conventional ‘QWERTY’ keyboard layout. However, the teachings of the invention have equal applicability to any other form of key layout, such as the well-known Dvorak layout, a simple alphabetic layout, or even a random key layout.

The embodiments provided have focused on implementations involving video game consoles and equipment. However, the invention is not limited to video game console products. Rather, the invention has equal applicability to many other products, such as general or special purpose computers with input mechanisms having limited controls. These and many other alternatives and enhancements are all envisioned as within the scope of the invention.

Reference has been made throughout this specification to “one embodiment,” “an embodiment,” or “an example embodiment” meaning that a particular described feature, structure, or characteristic is included in at least one embodiment. Thus, usage of such phrases may refer to more than just one embodiment. Furthermore, the described features, structures, or characteristics may be combined in any suitable manner in one or more embodiments.

One skilled in the relevant art may recognize, however, that embodiments may be practiced without one or more of the specific details, or with other methods, resources, materials, etc. In other instances, well known structures, resources, or operations have not been shown or described in detail merely to avoid obscuring aspects of the embodiments.

While example embodiments and applications have been illustrated and described, it is to be understood that the invention is not limited to the precise configuration and resources described above. Various modifications, changes, and variations apparent to those skilled in the art may be made in the arrangement, operation, and details of the methods and systems disclosed herein without departing from the scope of the claimed invention.

What is claimed is:

1. A computer-readable medium encoded with computer-executable instructions for performing input using a handset having at least two controls, the instructions comprising, in no particular order:
receiving a first signal from a first control of the handset;
selecting a first character based on the first signal, the first character being within a first subset of a group of characters;
receiving a second signal from a second control of the handset; and
selecting a second character based on the second signal, the second character being within a second subset of the group of characters,
wherein the first and second subsets of the group of characters are distinguished according to spatial relationships between the characters in the group of characters as rendered on a graphical display.

2. The computer-readable medium recited in claim 1, wherein the handset comprises a game controller.

3. The computer-readable medium recited in claim 1, wherein the first control comprises a first joystick.

4. The computer-readable medium recited in claim 3, wherein the second control comprises a second joystick.

5. The computer-readable medium recited in claim 1, wherein the first and second controls are each selected from a group comprising a joystick, a selection button, a trigger button, and a directional pad.

6. The computer-readable medium recited in claim 1, wherein the group of characters comprises a simulated keyboard layout.

7. The computer-readable medium recited in claim 6, wherein the simulated keyboard layout comprises a QWERTY key layout.

8. The computer-readable medium recited in claim 1, wherein the group of characters comprises an alphabet of letters and numbers.

9. The computer-readable medium recited in claim 1, wherein the handset comprises a game controller, the first control comprises a joystick, the second control comprises a joystick, the group of characters comprises an alphabet and numbers, the first subset comprises a left part of a rendered version of the alphabet and numbers, and the second subset comprises a right part of the rendered version of the alphabet and numbers.

10. A computer-readable medium encoded with computer-executable components for achieving text input, the components comprising:
a key layout including a first subset of characters and a second subset of characters, the first and second subsets of characters being distinguished according to spatial relationships between the characters as rendered on a graphical display; and
a key layout manager configured to detect a first signal from a first control of a handset and a second signal from a second control of the handset, the key layout manager being further configured to select a first character in the first subset of characters based on the first signal and to select a second character in the second subset of characters based on the second signal.

11. The computer-readable medium recited in claim 10, wherein the first and second subsets of characters together comprise a simulated keyboard layout.

12. The computer-readable medium recited in claim 11, wherein the simulated keyboard layout comprises a QWERTY key layout.

13. The computer-readable medium recited in claim 11, wherein the first and second subsets of characters comprise an alphabet of letters and numbers.

14. The computer-readable medium recited in claim 10, wherein the handset comprises a game controller.

15. The computer-readable medium recited in claim 14, wherein the first and second controls of the game controller comprise joysticks.

16. A computer-readable medium encoded with a data structure, comprising:
a first subset of characters mapped to signals associated with a first control of a handset; and
a second subset of characters mapped to signals associated with a second control of the handset,
wherein the first and second subsets of characters are distinguished according to spatial relationships between the characters as rendered on a graphical display.

17. The computer-readable medium recited in claim 16, wherein the first and second subsets of characters together comprise a simulated keyboard layout.

18. The computer-readable medium recited in claim 17, wherein the simulated keyboard layout comprises a QWERTY key layout.

19. The computer-readable medium recited in claim 16, wherein the handset comprises a game controller.

20. The computer-readable medium recited in claim 19, wherein the first and second controls of the game controller comprise joysticks.
